(19) United States
(12) Patent Application Publication
(10) Pub. No.: US 2022/0146402 A1
(43) Pub. Date: May 12, 2022

(54) OPTICAL PARTICLE DETECTOR

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); CPE LYON, Villeurbanne (FR); ECOLE CENTRALE DE LYON, Ecully (FR); INSTITUT NATIONAL DES SCIENCES APPLIQUEES DE LYON, Villeurbanne (FR); UNIVERSITE CLAUDE BERNARD LYON 1, Villeurbanne (FR)

(72) Inventors: Gabriel JOBERT, Grenoble Cedex 09 (FR); Salim BOUTAMI, Grenoble Cedex 09 (FR); Maryse FOURNIER, Grenoble Cedex 09 (FR); Christian SEASSAL, Saint-Didier au Mont d'Or (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); CPE LYON, Villeurbanne (FR); ECOLE CENTRALE DE LYON, Ecully (FR); INSTITUT NATIONAL DES SCIENCES APPLIQUEES DE LYON, Villeurbanne (FR); UNIVERSITE CLAUDE BERNARD LYON 1, Villeurbanne (FR)

(21) Appl. No.: 17/416,268

(22) PCT Filed: Dec. 23, 2019
(86) PCT No.: PCT/EP2019/086982

§ 371 Date: Jun. 18, 2021

(30) Foreign Application Priority Data
Dec. 21, 2018 (FR) 1874037

(51) Int. Cl. G01N 15/14; G02B 5/08; G02B 1/00; G02B 17/00

(52) U.S. Cl. CPC G01N 15/1434; G02B 17/004; G02B 1/005; G02B 5/0825

(57) ABSTRACT

A particle detector includes at least one resonant cavity partially formed at least by a first reflector, a second reflector disposed at a distance from the first reflector and a channel located between the first and second reflectors, the channel being intended to receive at least one fluid comprising particles and to receive at least one light radiation; and at least one detection system having at least one photodetector. The particle detector is configured so that a portion of the light radiation present in the channel escapes from the cavity throughout the second reflector and reaches the detection system, thereby enabling the at least one photodetector to detect leakage of the cavity. The second reflector is a photonic crystal membranes PCM based reflector.

### TECHNICAL FIELD

The present invention relates to the field of optical detection of particles in general and more particularly micrometer-, and possibly nanometer-, sized particles. It will find a particularly advantageous, yet non-limiting, application in the detection of fires, the control of air quality, the detection of microbiological species, the detection of explosive powder. Hence, the present invention is particularly advantageous for forming alarm systems, in particular alarm systems that are barely sensitive to false positives, such as alarm systems identifying fume particles to detect fires and air quality control systems.

### STATE OF THE ART

Particles are solid, liquid or wet solid microscopic objects in suspension in air. Their sizes vary from a few tens of nanometers to a few tens of micrometers. These particles originate from various sources such as forest fires, construction sites, industrial sites, motorized vehicles, etc.

When the concentration of these particles exceeds a determined threshold, they have a detrimental impact on the environment and/or health. Thus, some states have set maximum concentration thresholds. For example, the European Union tolerates maximum concentrations of 50 μg/m³ for particles with a size comprised between 10 μm and 2.5 μm and of 25 μg/m³ for particles with a size smaller than 2.5 μm.

Hence, it is necessary to accurately detect the presence and the concentration of these particles.

In general, particle detectors are based on the analysis of scattering of light by particles. Thus, in general, these detectors include optical sensors configured so as to measure scattering of light by the particles.

The detectors comprise a light source which illuminates a channel through which the particles to be detected pass.

If particles are present in the illuminated area, these will absorb the light that comes from the source and at the same time will divert this light off the main direction of propagation according to the scattering phenomenon. The scattering angular efficiency is characteristic of the shape, the size, the optical index and the concentration of the particles. Hence, recording this scattering angular efficiency allows analysing these different parameters of the particles.

As regards the optical detection of particles, there are two main detection methods. The first method is a so-called obscuration measurement, that is to say the measurement of the absorption of light through a cloud of particles or a build-up of particles. This measurement allows determining the concentration of the particles using Beer-Lambert law if the composition of the cloud of particles is known beforehand.

The second method is a measurement of light scattered off the optical axis. This measurement allows determining the concentration of particles according to light scattering theories, for example Mie's theory (Ref: Bohren and Huffmann, Absorption and scattering of light by small particles, Ed. Wiley and Sons, 1983). To analyse the nature of the particles of the cloud, it is possible, for example, to proceed with an angular measurement of scattering, for example using a goniometer constituted by a photodetector mounted on a rotary arm, or using a discrete assembly of photodetectors.

This type of detectors has the drawbacks of being very complex, very expensive and barely robust. Thus, it cannot be transported easily. Moreover, it could not be considered to equip low-cost alarm or measuring systems. Yet, for example, for the field of fire detection in homes or for the field of air quality control, it is necessary to provide solutions whose costs are low and whose robustness is high.

Other optical detection methods have also been proposed.

For example, optical particle counters operate based on the above-mentioned two principles, with the difference that the particle-light interaction area is geometrically limited by focusing of a laser source and/or by a microfluidic channel. This geometric limitation of the active area allows detecting unique particles rather than clouds.

Other optical methods consist in observing particles by processing of images obtained by microscopy or by holographic reconstruction.

These methods also feature a relatively low robustness and a high cost. In order to improve the robustness of the particle detectors and reduce the cost thereof, solutions have been proposed to integrate optical detectors into chips using microelectronics and photonics technologies.

The document FR2963101 describes such a solution. This solution provides for a source of light conveyed by a waveguide that illuminates a channel etched in a silicon substrate and through which particles will circulate. Scattering of the incident light by these particles is detected by two peripheral photodetectors formed on the silicon substrate.

This solution allows reducing the bulk of the sensor. Yet, with this type of solutions, it is extremely difficult to obtain sufficiently accurate and complete information on the particles. In particular, it is difficult, and even impossible, to analyse or determine the nature of the particles.

The document US 2016/0077218 A1 also describes a detector formed on a chip and comprising an array of photodetectors used to capture an image of the radiation scattered by the particles. Also with this solution, it is hard to accurately analyse or determine the nature of the particles.

Moreover, this type of solutions has the drawback of being barely sensitive, in particular for small particles, for examples particles that have an apparent diameter smaller than 1 μm.

The document WO 2018/150044 describes a detector comprising an optical cavity comprising a channel for the passage of the particles and delimited by facing reflective surfaces. The detector is configured so that a portion of the light rays scattered by the particles of the channel is reflected on the reflective surfaces before reaching an array of photodetectors. Part of the reflective surfaces is formed by Bragg mirrors.

There are still other methods, non-optical this time, for detecting particles.

Among these non-optical detection methods, gravimetric measurement consists in measuring the mass of a build-up of particles. One variant consists in measuring the mass of one single particle using an oscillating balance.

Another non-optical method, the detection of particles by ionisation, consists in measuring the variation of the current induced by an ionised air chamber when there are particles. Moreover, the measurement by beta attenuation consists in measuring the attenuation of a beta radioactive source through a cloud of particles using a Geiger counter.

However, the non-optical methods that have been proposed so far feature higher levels of complexity than optical detection methods.

Hence, there is a need for providing a solution to improve the sensitivity of the detection of particles, in particular particles whose dimension is smaller than 1 μm, for example, in order to determine the nature thereof, while featuring a limited level of complexity or cost. This is the objective of the present invention.

### SUMMARY

The present invention relates to a particle detector comprising at least:
at least one resonant cavity partially formed at least by a first reflector, a second reflector disposed at a distance from the first reflector and a channel located between the first and second reflectors, the channel being intended to receive at least one fluid comprising particles and to receive at least one light radiation;
at least one detection system comprising at least one photodetector,
The detector is configured so that a portion of the light radiation present in the channel escapes from the cavity throughout the second reflector and reaches the detection system, thereby enabling the at least one photodetector to detect leakages of the cavity,
Moreover, the second reflector is a photonic crystal membranes PCM based reflector.

Thus, the detection system detects the leakages originating from the optical cavity, the variation of these leakages being dependent on the presence of particles in the channel. While in the absence of any particle in the channel, the cavity mode has one single direction of incidence on the second reflector (in the case where the second reflector is planar, this incidence is perpendicular to the plane of the second reflector), in the presence of at least one particle, this cavity mode is disturbed. The cavity mode has partially vanished and non-vertical diffractive modes appear.

In a particularly advantageous manner, a PCM generates leakages whose diagram, called “leakage” diagram, is characteristic of the cavity resonant mode. Thus, the disturbance of the cavity mode also modifies the leakage diagram that is read at the network of photodetectors.

This disturbance is characteristic of the nature of the disturber and therefore allows identifying the particle(s) present in the cavity.

The presence of a photonic crystal membranes based reflector allows detecting this disturbance of the leakage diagram with a high sensitivity. In particular, the presence of such a reflector allows collecting on the network of photodetectors an angular analysis for particles with small dimensions, and that being so even for large diffraction angles.

This allows detecting and analysing very small-size particles, typically particles whose size is smaller than 500 nm, and possibly smaller than 250 nm, which is particularly difficult with conventional light scattering methods.

Moreover, by disposing the network of photodetectors behind the second reflector, the network of photodetectors is not dazzled in contrast with the case where it would have been directly facing the source.

Thus, the invention offers particularly significant advantages.

In particular, should the cavity have been formed by two reflectors constituted by Bragg mirrors, the network of photodetectors would not have allowed collecting sufficiently accurate angular information. A photonic crystal has a better angular signature than a metallic mirror or a Bragg mirror.

Moreover, the obtained signal would have been particularly low for large angles. Thus, with a cavity formed only by Bragg mirrors, it would not have been possible, for example, to identify whether a disturbance is due to the presence of a big particle or of a plurality of small particles. Hence, the detector provided by the invention offers considerably improved accuracy and sensitivity.

Moreover, the sensitivity of the detector according to the invention allows using low-energy sources even for small-size particles. It is even possible that the source consist of Sun light. On the contrary, with the solutions mentioned in the section relating to the state of the art, very luminous, and therefore very energy-intensive, sources should be used since the scattering efficiency is low for small particles.

The present invention also relates to a detection system comprising first and second detectors according to the invention, the cavity of the second detector, called reference cavity, being tight so as to prevent particles from penetrating into the reference cavity, the system being further configured so as to couple data supplied by the detection system of the first detector with data supplied by the detection system of the second detector.

This embodiment allows getting rid of the portions of signals that are not due to the presence of a particle, such as the signature of the imager or a parasitic lighting due to the source, etc. This embodiment allows improving even further the sensitivity of the detector. The present invention also relates to a system comprising a detector according to the invention wherein the system is selected amongst:
a fire alarm system,
a fire detection system,
a system for analysing the quality of a fluid such as air or water,
a pollution alarm system,
an explosive powder detection system,
a microbiological species detection system.

The present invention also relates to a method for manufacturing a particle detector, comprising at least the following steps:
provide at least one stack comprising a first reflector,
provide at least one stack comprising a second reflector, the second reflector being PCM based,
make pillars,
assemble the first reflector and the second reflector so that the first reflector and the second reflector are located on either side of the pillars to form between the pillars a channel for the passage of the fluid.

According to an optional example, the method comprises at least the following optional steps:
prior to the assembly of the first reflector and of the second reflector, a sacrificial layer is provided over one amongst the first reflector and the second reflector,
prior to or after the assembly of the first reflector and of the second reflector, a portion of the sacrificial layer is removed so as to form the channel while keeping another portion of the sacrificial layer so as to form said pillars.

This method is particularly simple and inexpensive to implement.

According to another optional example, the method comprises at least the following optional steps:
make a spacer comprising said pillars,
the assembly of the first reflector and of the second reflector comprises the positioning of the spacer between the first reflector and the second reflector.

This method allows making detectors whose fluid passage channel has a large thickness.

### BRIEF DESCRIPTION OF THE FIGURES

The aims, objects, as well as features and advantages of the invention will appear better from the detailed description of the embodiments of the latter which are illustrated by the following appended drawings wherein:

FIGS. 1A and 1B are principle diagrams illustrating the leakages of a vertical cavity in the absence of any particle (FIG. 1A) and in the presence of one particle (FIG. 1B).

FIG. 2 is a schematic illustration, in perspective, of an example of a detector according to the invention.

FIG. 3 is a principle illustration of a detector according to the invention, equipped with an illumination system according to a first embodiment.

FIG. 4 is a principle illustration of a detector according to the invention, equipped with an illumination system according to a second embodiment.

FIG. 5 is a principle illustration of a detector according to the invention, equipped with an illumination system according to a third embodiment.

FIG. 6 illustrates the results of a FDTD simulation of scattering of the power in an optical cavity according to an embodiment of the present invention, a particle being present in the optical quality.

FIGS. 7A-7C are simulations illustrating the radiation diagram in one dimension of detectors in the presence of particles whose diameters vary from 50 nm to 0.9 μm. FIG. 7A is a simulation illustrating the radiation diagram for a detector according to an embodiment of the invention and whose optical cavity is identical to that one having resulted in the simulation illustrated in FIG. 6.

FIG. 7B is a simulation illustrating the radiation diagram for a detector having a cavity using Bragg mirrors to form the upper reflector and the lower reflector.

FIG. 7C is a simulation illustrating the radiation diagram for a detector comprising no cavities, the particles then scattering directly on the photodiodes.

FIGS. 8A to 8F illustrate steps of a first example of a method for making a detector according to the invention.

FIGS. 9A to 9F illustrate steps of a second example of a method for making a detector according to the invention.

FIG. 10 schematically illustrates a system comprising two resonant cavities 100, 100′. The drawings are provided as examples and do not limit the invention. These drawings are schematic representations and are not necessarily to the scale of the practical application. In particular, the relative dimensions of the different layers, membranes, patterns, reflectors, cavity, photodetectors and other structures are not representative of the reality.

### DETAILED DESCRIPTION

In the present description, the following terms are considered to be equivalent: “reflector with photonic crystal membranes”, “photonic crystal membranes based reflector”, “photonic crystal membrane based reflector”, “reflector with a membrane with photonic crystals”. In the following description, for reasons relating to homogeneity, the term “photonic crystal membranes based reflector” or “PCM-based reflector” will be used, PCM being the acronym of “Photonic Crystal Membrane”.

In general, a PCM-based reflector comprises at least one layer, also referred to as membrane, comprising photonic crystals. This type of reflectors may comprise additional layers, such as encapsulation layers which cover the membrane comprising the photonic crystals. Hence, the PCM-based reflector may be formed by a stack of layers.

According to a non-limiting example, the thickness of the layer or membrane comprising photonic crystals is comprised between λ/15 and λ/2.

Moreover, it is possible to provide for a PCM-based reflector comprising several superimposed layers, whether adjacent or not, and each formed by photonic crystal membranes. In this case, we will talk about a three-dimensional photonic crystal.

For the manufacturing of these PCM-based reflectors, reference may be made in particular of the following publication: “Periodic nanostructures for photonics”, published in Physics Reports, Volume 444, Issue 3-6, p. 101-202., Busch, K.; von Freymann, G.; Linden, S.; Mingaleev, S. F.; Tkeshelashvili, L.; Wegener, M., 10.1016/j.physrep.2007.02.011.

It is specified that in the context of the present invention, the term “on”, “surmounts”, “covers” or “underlying” or their equivalents do not mean “in contact with”. Thus, for example, the deposition of a first layer over a second layer, does not necessarily mean that the two layers are directly in contact with each other but this means that the first layer covers at least partially the second layer by being either directly in contact therewith, or by being separated therefrom by at least one other layer or at least one other element.

Unless specifically stated otherwise, technical features described in detail for a given embodiment may be combined with the technical features described in the context of other embodiments described as a non-limiting example.

In the context of the present invention, the term “particle” or its equivalents refers to a constituent of a physical system considered as elementary with regards to the studied properties.

The term particles refers in particular to a solid, liquid or wet solid object in suspension in air and whose size is microscopic. For example, a particle is a matter element whose largest dimension is smaller than a few millimeters (10⁻³ meters), preferably one millimeter, and preferably a few tens of micrometers (10⁻⁶ meters) and preferably smaller than one micrometer, and possibly in the range of one nanometer (10⁻⁹ m). More generally, the particles have a size larger than 40 Å (10⁻¹⁰ m) and are therefore considered to be optically continuous. In general, it consists of objects composed by matter whose dimensions are small in comparison with the dimensions of the cavity or of the channel for particles circulation.

By “size” or “diameter” of a particle, it should be understood the maximum distance between two points of the particle. Typically, a particle is assimilated to an object with a spherical size, its size therefore corresponds to the diameter of the sphere.

By a reflector, a waveguide, a film, a layer, “based” on a material A, it should be understood a substrate, a film, a layer comprising only this material A or this material A and possibly other materials, for example doping elements. Thus, if a reflector is referred to as being “silicon-based”, this means that it may be formed only by silicon or by silicon and possibly other materials, dopants or others.

Thus, if a reflector is referred to as being “PCM based”, this means that it could be formed only by photonic crystal membranes or by photonic crystal membranes as well as other materials.

In the present description, a material is considered to be transparent when it lets at least 50% of a light radiation pass, preferably at least 75% and advantageously at least 90%.

In the following, the term “diffraction”, “scattering” or their equivalents refer to the phenomenon by which a propagation medium produces a spread, in numerous directions, of the energy of an electromagnetic wave, a light wave for example.

In the following, the term “reflection” or its equivalents refers to the phenomenon of re-emission of an incident light radiation from an element or a surface. In the present description, an element is considered to be reflective when it re-emits at least one portion of an incident light radiation, this portion being larger than or equal to 50%. A reflectivity coefficient varies from 0% for a non-reflective element to 100% for an element reflecting all of an incident light radiation.

Before starting a detailed review of embodiments of the invention, optional features that could possibly be used in combination or alternatively are set out hereinafter:
According to one example, the first reflector and the second reflector are disposed facing one another, extend in two parallel planes and are configured so as to form a resonant optical cavity having a cavity mode perpendicular to the planes in which the first reflector and the second reflector primarily extend.
According to one embodiment, the detector comprises a unique resonant cavity comprising a channel located between the first and second reflectors, the channel being intended to receive at least one fluid comprising particles and to receive at least one light radiation. This unique cavity allows providing angular information on scattering of the particle(s) present in the channel.
According to one example, the channel is configured so as to channel an air stream that crosses the cavity by flowing between the first and second reflectors. The channel is configured so as to channel an air stream that runs along the first and second reflectors.
According to one example, the channel is open-through. It enables a flow of the fluid between the first and second reflectors. Thus, it enables a flow of the fluid inside the cavity.
According to one example, the channel is entirely located between the first and second reflectors.
According to one example, the first reflector is physically remote from the second reflector. They are separated by at least one different material that is not a photonic crystal membranes PCM based element such as a PCM-based reflector for example.
According to one example, the detection system includes a network of photodetectors arranged in the form of an array of photodetectors.
According to one example, it is formed by an array of photodiodes, the array being linear or two-dimensional. Typically, the detection system forms an imager such as an array of pixels or of photodiodes.
According to one example, the first reflector and the second reflector are planar reflectors. According to one example, each extends in one plane.
Alternatively, each of the first reflector and second reflector forms a curved web. Thus, they extend in a non-planar manner. Nevertheless, the webs according to which they extend could be parallel.
According to one example, whether the first and second reflectors are planar or not, the first reflector is disposed facing the second reflector so as to form a resonant optical cavity. The resonant optical cavity has a cavity mode perpendicular to the web according to which the second reflector extends, that is to say perpendicularly to the plane in which the second reflector extends if it is planar.
Alternatively, the reflectors may be non-planar. They are curved. This allows having an optically more stable cavity.
According to one example, the first reflector comprises or is composed by at least one Bragg mirror. Alternatively, the first reflector is photonic crystal membranes PCM based.
The second reflector comprises at least one photonic crystal membrane PCM or is formed by a photonic crystal membrane PCM.
According to one example, the PCM-based reflector has patterns made of a dielectric material and disposed periodically. Preferably, at least one of the features of the PCM-based reflector, amongst the size of the patterns, the shape of the patterns, the period of the patterns, the thickness of the patterns (thickness of the layer with the highest refractive index, from which the patterns are formed) and the refractive index of the PCM-based reflector is selected so that the maximum reflectivity of the PCM-based reflector corresponds to a wavelength belonging to the visible spectrum (380 to 780 10⁻⁹ meters) or near-infrared (780 10⁻⁹ to 3 10⁻⁶ meters) range, which allows considerably limiting the costs of the detector.

According to one example, the PCM-based reflector comprises patterns made of a dielectric material and at least one encapsulation layer covering said patterns and having a planar face, the at least one encapsulation layer being preferably made of a dielectric material.

Preferably, the encapsulation layer has a refractive index lower than the highest refractive index composing the membrane.

Thus, the patterns are buried in the encapsulation layer. Thus, they do not form any projections at the surface of the reflector so as not to interact with a particle that would deposit on the latter.

Thus, this embodiment allows limiting the risks of fouling of the PCM-based reflector. Thus, the reliability and the longevity of the detector are enhanced.

According to one example, the detector comprises at least one illumination system configured so as to convey the at least one light radiation into the cavity.

According to one example, the illumination system is configured so as to convey the at least one light radiation into the channel throughout the first reflector.

According to one example, the first reflector has an inner face facing the channel and an outer face opposite to the inner face, the illumination system being configured so as to convey the at least one light radiation onto the outer face of the first reflector in the cavity. This embodiment is partially simple to implement. It allows considerably limiting the cost of the detector.
According to another example, the second reflector has an inner face facing the channel and an outer face opposite to the inner face. The illumination system comprises an injection waveguide configured so as to convey a luminous flux onto said outer face so as to excite the second reflector by evanescent-wave coupling.
According to another embodiment, the first reflector is PCM based. It has an inner face facing the channel and an outer face opposite to the inner face. The illumination system comprises an injection waveguide configured so as to convey the luminous flux onto said outer face so as to excite the first reflector by evanescent-wave coupling.

These embodiments have the advantage of being barely bulky.

Moreover, they have the advantage of allowing for an easy integration when the detector is made by conventional microelectronics techniques, in particular techniques of etching on silicon.

Moreover, in these embodiments, the thickness of the reflector coupled to the injection guide does not need to have an identical thickness and/or an identical material as those of the injection waveguide. This allows alleviating the manufacturing constraints. Advantageously, the injection guide is based on silicon.
According to yet another example, the illumination system comprises an injection waveguide configured so as to guide the light radiation originating from a source up to the second PCM-based reflector, the second reflector being configured so as to scatter within the channel the light radiation received from the injection waveguide. The at least one pattern of the second PCM-based reflector has a flank. The injection waveguide is configured so as to guide the luminous flux originating from the source up to the flank of the second PCM-based reflector.
According to another embodiment, the first reflector is PCM based and has a flank. The illumination system comprises an injection waveguide configured so as to guide the light radiation up to the flank of the first PCM-based reflector.
Thus, one of the two PCM-based reflectors is fed by the flank.
This embodiment has the above-mentioned advantages in terms of integration by conventional microelectronics technics. Furthermore, the optics are particularly simple.

In one embodiment, the first reflector, or upper reflector, is a PCM-based reflector. It may then be considered that the injection guide is coupled to this first reflector.

According to one example, the detector comprises a light source optically coupled with the illumination system, the source being a laser or a light-emitting diode LED. Alternatively, the source is the Sun.

According to one example, the detector comprises an optical device, such as a lens, disposed between the second reflector and the detection system, the optical device being configured so that the image of the cavity mode is located in the reciprocal space of the second reflector.

This embodiment allows refining even further the analysis of the disturber.

A preferable field of application of the present invention is the detection of particles of various sizes, preferably in the range of microscopic, and possibly nanometric, particles. For example, the present invention could be used in the detection of particles derived from fumes, explosive powder, polluting particles, dust particles, allergenic particles such as pollens, mold spores, or carcinogenic particles, or biological particles such as bacteria, viruses, or exosomes.

The present invention applies to any type of particles conveyed by a fluid, whether this is liquid and/or gaseous.

For example, the fluid present or flowing in the channel is air. This is the case for the detectors integrated in the following systems: a fire alarm system, a fire detection system, an explosive powder detection system, a system for analysing the quality of a fluid such as air, a pollution alarm system.

Alternatively, the fluid may be a liquid such as water. This is the case for the detectors integrated in microbiological species detection systems.

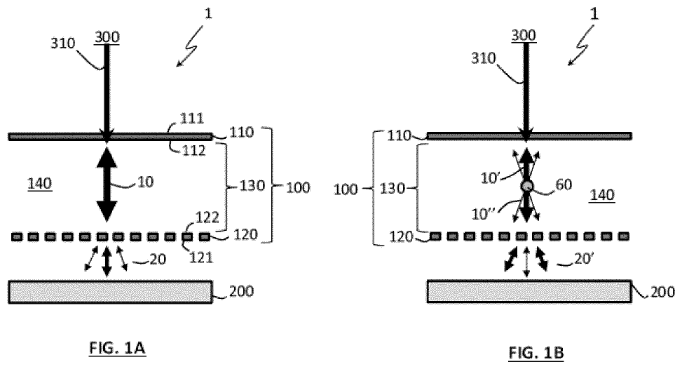

A simplified example of a detector according to the invention will now be described with reference to FIGS. 1A and 1B, to understand the operating principle thereof.

As illustrated in this diagram, the detector 1 comprises a first reflector 110 and a second reflector 120. These two reflectors 110, 120 are at distance from one another so as to define a space forming a channel 140 for the circulation of a fluid likely to contain particles.

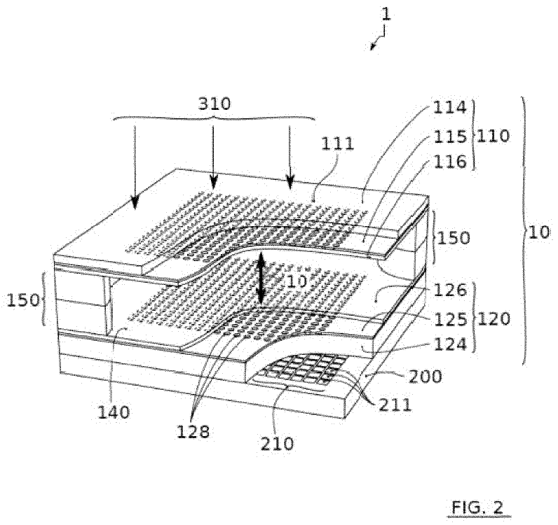

The structural elements allowing keeping the two reflectors 110, 120 at a distance from one another are not illustrated in this principle diagram. For example, these elements consist of pillars that leave large openings cleared enabling the fluid to flow in the channel 140. For example, it is possible to provide for pillars disposed in planes parallel to that one of the sheet. These structural elements appear in FIG. 2 where they bear the reference numeral 150.

The detector 1 is coupled to an optical source 300 and to an illumination system configured so as to convey a light radiation 310 from the source 300 up to the channel 140. Preferably, the source is distinct from the detector. This allows changing or manufacturing the source independently of the detector. For example, the source may be a laser, a LED or even the Sun.

The detector 1 is configured so as to form a resonant optical cavity 100 delimited by the first 110 and second 120 reflectors.

In particular, the source 300 is selected so that it feeds a cavity mode 10 with a specific wavelength in particular according to the spacing between the two reflectors 110, 120 and to their reflectivity spectrum. Preferably, the operating wavelength(s) lies/lie within the visible spectrum (380 to 780 nm) or near-infrared (780 nm to 3 μm) range, which allows considerably limiting the costs of the detector 1. Typically, the source 300 is a light-emitting diode LED or a laser.

For example, the first reflector 110 is a Bragg mirrors-based reflector.

The second reflector 120 is a photonic crystal membranes (PCM) based reflector. Alternatively, the first reflector 110 may also be PCM based. According to one embodiment, each of the first 110 and second 120 reflectors extends according to one plane. In the examples illustrated in FIGS. 1A and 1B, this plane is perpendicular to that one of the sheet. Hence, these consist of planar reflectors. According to other embodiments falling within the scope of the present invention, the reflectors are not planar. They may be curved. This is the case for example if the reflectors are suspended. Moreover, it might be useful to bend the reflectors, by applying stresses, in order to have an optically more stable cavity. While being curved, the first 110 and second 120 reflectors could still be parallel.

The first reflector 110 and the second reflector 120 form together a vertical resonant cavity 100. If the first 110 and second 120 reflectors are planar, the cavity mode 10 has an incidence perpendicular to the main plane in which the first 110 and second 120 reflectors extend. In FIGS. 1A and 1B, this cavity mode 10 is therefore vertical.

The detector 1 also comprises a detection system 200. For example, this detection system 200 comprises a network of photodetectors 211 such as an array of photodiodes. The array may be linear or two-dimensional.

The detector 1 is arranged so that a portion of the luminous flux conveyed into the cavity 100 escapes from the latter through the second reflector 120 and reaches the detection system 200.

According to the illustrated embodiment, the photodetectors 211 and the channel 140 are disposed on either side of the second reflector 120. More specifically, the second reflector 120 has an inner face 122 facing the channel 140 and an outer face 121 opposite to the inner face 122.

The second reflector 120 being disposed between the cavity 100 and the detection system 200, it allows avoiding the latter being dazzled by the luminous flux present in the channel 140.

The PCM-based second reflector 120 induces a radiation or leakages which escape from the cavity 100. In a particularly advantageous manner, this reflector 120 has a “radiation” diagram, also called “leakage” diagram 20, which is characteristic of the cavity resonant mode 10. Thus, the analysis of the variations of the leakage diagram allows identifying, with a high sensitivity, a disturbance of the cavity mode 10 and, consequently, detecting the presence of a disturber within the channel 140.

This principle clearly comes out from the schematic illustrations of FIGS. 1A and 1B. FIG. 1A represents the detector 1 in the absence of any particle within the channel 140. The luminous flux 310 generates an excited mode 10 centered on the point r of the reciprocal space of the second PCM reflector 120, that is to say in normal incidence in the illustrated example. Next, an excited mode at the point r of the reciprocal space of the second reflector 120 is called a “Γ mode”.

Hence, in the absence of any particle, the detection system 200 receives the leakage diagram 20 specific to the cavity Γ mode 10.

FIG. 1B represents the detector 1 in the presence of a particle 60 within the channel 140. This particle 60 disturbs the cavity mode. The Γ mode 10′ is attenuated and non-vertical diffractive modes 10″ appear. This disturbance of the cavity mode modifies the leakage diagram 20′. This modification of the leakage diagram 20′ is read at the detection system 200. This modification is characteristic of the nature of the disturber. Hence, it allows identifying the particle(s) 60 present in the cavity.

These disturbances are extremely sensitive, this allows detecting very small-size particles, which is particularly difficult with conventional light scattering methods.

The following document provides examples of resonant cavities whose reflector is PCM based: “Periodic nanostructures for photonics”, published in Physics Reports, Volume 444, Issue 3-6, p. 101-202., Busch, K.; von Freymann, G.; Linden, S.; Mingaleev, S. F.; Tkeshelashvili, L.; Wegener, M., 10.1016/j.physrep.2007.02.011.

Referring to FIG. 2, an example of a non-limiting embodiment of a detector according to the invention will now be detailed.

This detector 1 comprises a cavity 100 and a detection system 200 configured so as to detect the leakage diagram generated by the cavity 100.

The cavity 100 comprises a first reflector 110, a second reflector 120 disposed at a distance from the first reflector 110 so as to clear a free space forming a channel 140 for the circulation of the particles. Advantageously, the detector 1 comprises one single cavity 100 defining one single channel intended to receive a fluid conveying particles.

Pillars 150 keep the first 110 and second 120 reflectors at a distance from one another. The detector 1 is coupled to an illumination system allowing generating a light radiation. In this example, the illumination system brings the light radiation 310 onto an outer face 111 of the first reflector 110, so that the light radiation passes throughout the first reflector 110 before reaching the cavity 100.

The different elements of the detector 1 will be successively described in more detail hereinbelow.

According to a non-illustrated example, the first reflector 110 comprises or is formed by a Bragg mirror. According to an alternative example, and as illustrated in FIG. 2, the first reflector 110 may be a PCM-based reflector. For example, this reflector 110 is formed by a stack of layers comprising successively from an outer face 111 of the first reflector 110 opposite to the interior of the cavity 100:
an outer encapsulation layer 114,
a photonic crystal membrane 115,
an inner encapsulation layer 116.

The second reflector 120 is a PCM-based reflector. For example, this reflector 120 is formed by a stack of layers comprising successively from an outer face 121 of the second reflector 120 opposite to the interior of the cavity 100:
an outer encapsulation layer 124,
a photonic crystal membrane 125,
an inner encapsulation layer 126.

The photonic crystal membrane 115, 125 serves as a reflector. The photonic crystals 128 are planar and periodic patterns of a dielectric material. These patterns have a one-dimensional or two-dimensional periodicity. FIG. 2 illustrates an example wherein the patterns are one-dimensional. For example, they may form a hole throughout the membrane 125. They may also be formed by a volume of matter, for example a pad surrounded by a matrix. They may also form perfectly arbitrary and periodic patterns.

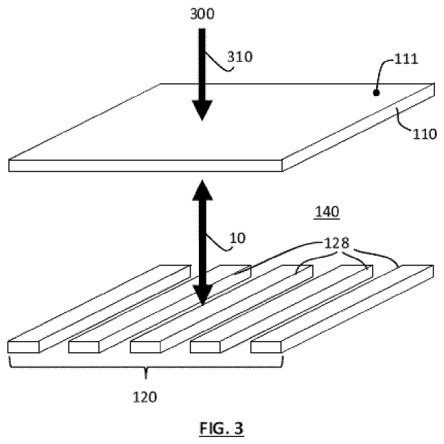

The examples of FIGS. 3 to 5 illustrate other patterns in one dimension, each pattern 128 forming a bar extending according to a main direction.

The patterns 128 of the PCM-based reflectors 110, 120 may be arranged according to any type of meshes.

The pattern (its size, its shape and its arrangement), the period of the network of patterns 128, the thickness and the refractive index of the membrane define the reflectivity spectrum of the PCM-based reflector. Ideally, the reflectivity is maximum in the visible and near-infrared spectral range.

Advantageously, the encapsulation layers allow burying the patterns. Preferably, they are planarised. This enables the PCM-based reflector to have planar faces. This limits the depositions and the retention of particles over the inner faces 112, 122 of the reflectors 110, 120. Thus, fooling of the detector is avoided and its reliability is preserved over time.

The reflectors 110, 120 occupy, in the planes in which they primarily extend, a surface ranging from a few square micrometers to a few square millimeters.

The channel 140 is an area in which particles can circulate. The two reflectors 110, 120 are spaced apart by pillars 150 or any structure that allows filling this function. Thus, the first 110 and second 120 reflectors are separated by at least one different material that is not a photonic crystal membranes PCM based part such as a PCM-based reflector for example. Should it be desired to free as much as possible the circulation of the particles in planes parallel to those in which the reflectors 110, 120 primarily extend, it is possible to reduce the section of the pillars 150. This solution aims to improve the fluidic response time of the detector 1. This embodiment is particularly advantageous when the circulation of the fluid in the channel 140 is free, that is to say it is not forced. Moreover, larger openings make the detector 1 less sensitive to fooling of the air area.

On the contrary, should it be desired to constrain the movement of the particles according to a determined direction, for example if the cavity is fed with the fluid by a forced air device such as a fluid pump, it is possible to structure the pillars 150 so as to form a directive fluidic channel 140.

This area has a thickness comprised between a few micrometers and a few millimeters.

Thus, as indicated hereinabove and as shown in FIG. 1a, 1b or 2, the channel is open-through. It enables a fluid flow between the first and second reflectors 110, 120 and inside the cavity 100. According to these examples, the channel 140 may be entirely located between the first 110 and second 120 reflectors.

Thus, as illustrated in the figures and described hereinabove, the channel 140 is configured so as to channel an air stream that crosses the cavity 100 by flowing between the first 110 and second 120 reflectors, more specifically by running along the first 110 and second 120 reflectors. The channel 140 is configured so that the air stream crosses the cavity 100 by flowing in contact with the inner face 112 of the first reflector 110 and with the inner face 122 of the second reflector 120.

The detection system 200 is an assembly of at least one photodetector 211. Preferably, the detection system 200 forms a network 210 of photodetectors 211 as illustrated in FIG. 2. Typically, it consists of an imager with an array of pixels or of photodiodes.

According to an optional and non-illustrated embodiment, the detector 1 comprises an optical device, such as a lens, located between the second reflector 120 and the network 210 of photodetectors 211 and configured so as to capture the image of the cavity mode 10, whether disturbed or not, in the reciprocal space of the second reflector 120. This allows refining even further the analysis of the disturber.

As mentioned before, in the example illustrated in FIG. 2, the illumination system applies the light radiation 310 onto the outer face 111 of the first reflector 110, so that the light radiation passes throughout the first reflector 110 before reaching the cavity 100. Preferably, the first reflector 110, preferably its inner face 112, is directly in contact with the pillars 150. Preferably, the second reflector 120, preferably its inner face 122, is directly in contact with the pillars 150. Preferably, the second reflector 120, and more particularly its outer face 121, is directly in contact with the detection system.

FIGS. 3 to 5 illustrate different embodiments of the illumination system.

In each of these figures, the first reflector 110 may be a PCM-based reflector, a reflector with a Bragg mirror or any other type of reflectors. In these figures, although the second reflector 120 is represented as a periodic arrangement of patterns 128 in the form of bars, any other type of patterns may be considered.

The embodiment illustrated in FIG. 3 provides for an illumination system similar to that one of FIG. 2. The resonant cavity 100 mode 10 is fed by lighting from above, through the first reflector 110. The light radiation 310 is conveyed by the illumination system onto the outer face 111 of the first reflector 110 and crosses this first reflector 110 before reaching the interior of the cavity 100.

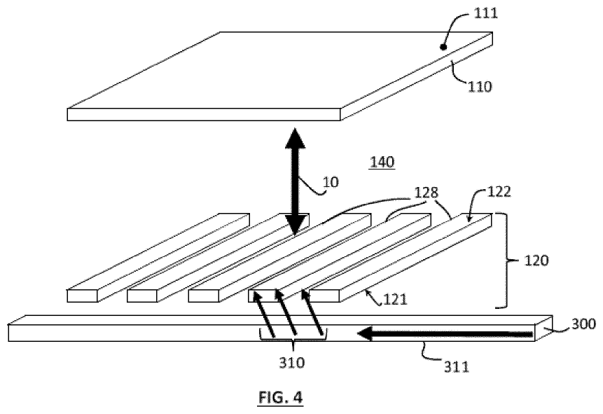

FIG. 4 illustrates an embodiment wherein the cavity 100 is fed from an outer face 121 of the second reflector 120, this outer face 121 being opposite to the interior of the cavity 100. In the example illustrated as a non-limiting example, the second reflector 120 being vertically located below the first reflector 110, it may be considered that lighting is done “from the bottom”.

Then, there is provided an injection waveguide 311, optically coupled to the source 300, which conveys the light radiation 310 up to the second reflector 120. The injection waveguide 311 excites the PCM-based reflector 120 by evanescent-wave coupling.

According to another non-illustrated embodiment, the first reflector 110 is also PCM based. In this case, it may be provided that it is actually the first reflector 110 rather than the second reflector 120 that is coupled to the injection waveguide 311 so as to be excited by evanescent-wave coupling.

Typically, the injection waveguide 311 is made by conventional microelectronics techniques, in particular by an etching technique, typically etching of thin layers such as a thin silicon layer. This allows facilitating the integration of the injection waveguide and of the illumination system and reducing the manufacturing costs of the detector. Moreover, in comparison with the embodiment illustrated in FIG. 3, this embodiment allows considerably reducing the bulk of the detector 1. Furthermore, the PCM-based reflector and the injection waveguide 311 are located on two different levels. Hence, these two elements may have different thicknesses and/or be made of different materials which allows alleviating the manufacturing constraints.

For example, the membrane may be made of silicon, SIN nitride, TIO2.

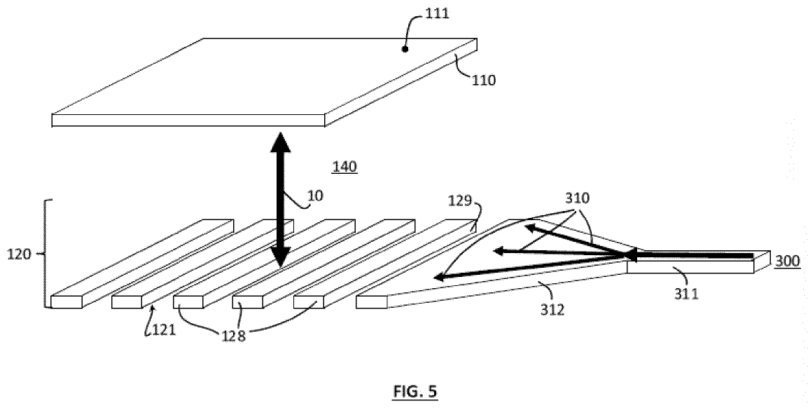

FIG. 5 illustrates an embodiment wherein the cavity 100 is fed by injecting the light radiation into the flank 129 of the membrane bearing the PCM 120 based patterns 128. To this end, it is possible to provide for an injection waveguide 311, optically coupled with a source 300, which has a portion 312 comprised in at least one plane identical to one of the planes in which the patterns 128 of the PCM-based reflector 120 primarily extend. The shape of this portion 312 is adapted to inject the light radiation along at least half, and preferably all, of the dimension of the flank 129 of at least one of the patterns 128. For example, if the patterns 128 form bars, as illustrated in FIG. 5, the portion 312 widens in the direction of at least one pattern 128 to enable the light radiation 310 to penetrate over the entire length of the flank 129 of this pattern 128. The portion 312 forms what is called a “taper”.

According to another non-illustrated embodiment, the first reflector 110 is also PCM based. In this case, it may be provided that it is actually the first reflector 110 rather than the second reflector 120 that is coupled to the injection waveguide 311 so as to be fed by the flank.

This embodiment has the same advantages as the previous embodiment, in terms of integration simplicity, in particular by conventional microelectronics techniques. Moreover, this embodiment allows reducing even further the bulk according to the direction perpendicular to the planes in which the reflectors 110, 120 primarily extend.

These excitation modes are described in the literature, for example in the thesis “Micro-nano structures à base de cristaux photoniques pour le contro̊le 3D de la lumière” (“Photonic crystal based micro-nano structures for 3D control of light”), Lydie Ferrier, 2008.

The excitation modes described in FIGS. 3, 4 and 5 can naturally be applied for patterns 128 other than bars and other than one-dimensional patterns.

For example, the source 300 is a LED or a LASER, this source must be able to feed a cavity mode 10 at a specific wavelength defined by the spacing between the two reflectors 110, 120 and by their reflectivity spectrum. In particular, this spacing is selected so as to enable the apparition of constructive interferences.

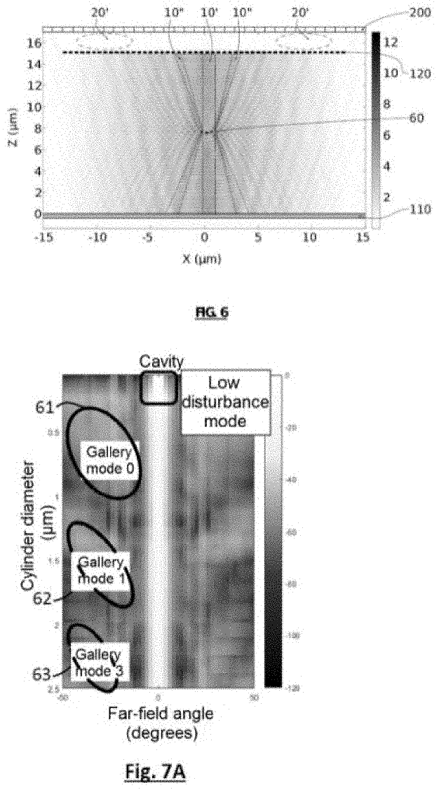

FIG. 6 is an example of a detector according to the invention simulated with the two-dimensional FDTD method (finite-difference time-domain method).

The simulated detector 1 is an optical cavity 100 comprising two reflectors spaced apart by 15 μm. The axis of abscissas Z is in micrometers. The reflector located at Z=0 μm corresponds to the first reflector 110. For this simulation, this first reflector 110 is formed by a Bragg mirror constituted by three alternations of thin layers of silica and amorphous silicon. The second reflector 120 is located at Z=15 μm. It consists of a PCM-based reflector, the patterns 128 being one-dimensional. These patterns 128 are constituted by amorphous silicon buried in silica.

A particle 60 having an optical index n=1.7 with a circular section is present in the channel 140. It is not necessarily present at the center of the cavity 100.

The cavity 100 is illuminated through the first reflector 110 with a Bragg mirror by a plane wave which propagates according to the axis Z. This plane wave has a wavelength around 850 nm, more specifically the closest wavelength to 850 nm that meets the constructive interference condition.

From an experimental perspective, it is possible for example to act on the power supply current of the LED or its temperature, to adjust the wavelength to the exact resonance of the cavity.

The detector 200 is placed behind the PCM-based reflector 120. The detector 200 spatially measures the leakages of the cavity 100 disturbed by the presence of the particle 60.

FIG. 6 illustrates the disturbance of the power supply (Poynting vector). A quite similar visual would be obtained when illustrating the disturbance of the field Ey. It comes out, from this simulation, that the cavity mode 10′ is disturbed and that diffractive modes 10″ appear in the channel 140. Moreover, it is observed that the leakage diagram is also disturbed 20′.

The nature of the particle 60, in particular its size, can be determined by measurement of the diagram of leakages coming out of this cavity 100.

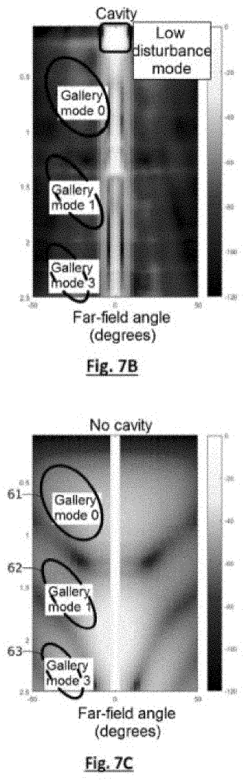

For example, in FIG. 7A, the radiation diagram in one dimension of the cavity 100 disturbed in the far-field for diameters of particles that vary from 50 nm to 0.9 μm.

FIGS. 7B and 7C are identical simulations yet carried out with detectors that are different from those of the invention.

FIGS. 7A to 7C clearly illustrate the advantages offered by the invention in terms of sensitivity, in particular to detect and analyse small-size particles.

In these figures, the powers are normalised with respect to the light excitation and are given in decibels. These three figures have the same scale which allows comparing them easily.

FIG. 7A illustrates the leakage diagram for a detector according to the example illustrated in FIG. 6. This simulation shows that the detection system 200 collects numerous and accurate angular information. In particular, the leakages of gallery modes 0, 1 and 2 appear clearly as illustrated by the reference numerals 61, 62, 63. Moreover, the detection system 200 collects a strong signal for all particles, including for particles whose size is smaller, and possibly significantly smaller than 500 nm, for example those smaller than 100 nm. This simulation also shows a low dazzling for zero or almost 0° angles.

FIG. 7B is a simulation illustrating the radiation diagram for a detector, not encompassed by the invention, having a cavity formed by an upper reflector and a lower reflector, each of these two reflectors being a Bragg mirror. In this example, the two reflectors are identical and each is formed by three alternations of a-Si/SiO2, a-Si meaning amorphous silicon. The simulation reveals that the angular information is poor. There are almost no gallery mode leakages. Moreover, the signal is low for large angles. Yet, the angular information is particularly important to accurately identify the size of the particles. In particular, low angular information does not allow determining whether a disturbance is due to one single large-sized particle or to several small particles. It clearly comes out from these simulations that the detector according to the invention allows significantly improving the sensitivity of the detection in comparison with detectors based on resonant cavities, both are formed by Bragg mirrors.

FIG. 7C is a simulation illustrating the radiation diagram for a second reference detector, not encompassed by the invention and comprising no cavities, scattering of the particle being directly performed on the network of photodetectors. At the 0° angle, a dazzling of the incident plane wave and a scattering diagram typical of a Mie scattering are observed. Such a detector outputs only but a very low signal for small-size particles, in particular those whose dimension is smaller than 500 nm.

When comparing the sensitivity of the device 1 according to the invention with the second cavity-less detector, and for small diameters of particles, for example 250 nm, scattered power ratios in the range of 30 decibels are obtained.

It clearly comes out that a detector according to the invention provides a significant gain in terms of sensitivity in comparison with a conventional cavity-less detector.

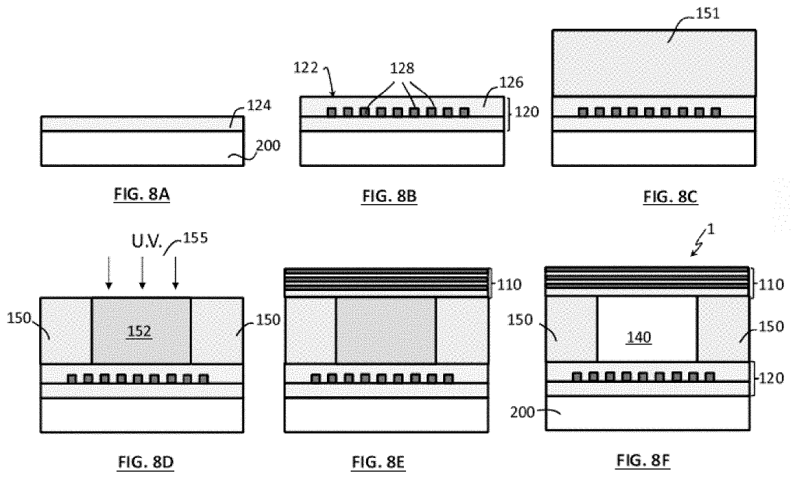

FIGS. 8A to 8F illustrate the main steps of a first example of a method for making a detector according to the invention.

As illustrated in FIG. 8A, a detection system 200 is provided. For example, this detection system 200 comprises a network 210 of photodiodes 211, such as an array of silicon photodiodes. Preferably, the detection system 200 is in the form of a wafer, also called plate. The detection system 200 is covered by a passivation layer, also called encapsulation layer 124. For example, this layer 124 is made of silica.

As illustrated in FIG. 8B, afterwards, a thin layer is deposited which is structured so as to constitute the photonic crystal 128 membrane 125. To make this photonic crystal structure, it is possible to resort to conventional microfabrication techniques. For example, the photonic crystal 128 membrane 125 is made of crystalline silicon, amorphous silicon, silicon nitride, titanium oxide or another material that is transparent in the useful spectral range. Afterwards, this membrane 125 is encapsulated by a passivation layer, also called encapsulation layer 126. Preferably, the face 122 of this passivation layer 126 that has remained free is planarised. This allows optically optimising the cavity and limiting fooling of the detector. For example, this encapsulation layer 126 is made of silica. Preferably, it has a low optical index in comparison with that one of the membrane 125.

Thus, the photonic crystal 128 membrane 125 is encapsulated between the layers 124 and 126. The stack formed by the encapsulation layer 124, the membrane 125 and the encapsulation layer 126 forms the PCM-based reflector 120.

As illustrated in FIG. 8C, a sacrificial layer 151 is deposited afterwards over the encapsulation layer 126, for example with a photosensitive material. For example, this material is a photosensitive resin that could be deposited for example by spin-coating. Preferably, the thickness of this layer is equal to the thickness of the air area defined by the channel 140 of the detector 1.

FIG. 8D illustrates the formation of the pillars 150. These pillars are obtained by structuring of the sacrificial layer 151. For example, if the sacrificial layer 151 is a positive photosensitive resin, it is possible to isolate 155 an area 152, outside the pillars 151, by means of ultraviolet radiation. The area 152 is not removed at this level and then, the sacrificial layer 151 is not etched at this step.

FIG. 8E illustrates the formation of the first reflector 110. In the illustrated example, this first reflector 110 is a Bragg mirror. Thus, the stack of the layers of the Bragg mirror is deposited over the face of the sacrificial layer 151 that has remained free. For example, this may consist of a periodic alternation of two layers of dielectric materials. These layers may be constituted by silica, crystalline silicon, amorphous silicon, silicon nitride, titanium oxide or another material that is transparent in the useful spectral range. According to a non-illustrated alternative embodiment, the first reflector 110 may be constituted by a PCM-based reflector, which is structured or which is affixed on top of the sacrificial layer 151.

As illustrated in FIG. 8F, the area 152 is removed, which allows defining the channel 140 enabling the passage of the fluid between the pillars 150.

The stack made in this manner constitutes at least one portion of the detector 1.

According to a variant of this embodiment, the sacrificial layer 151 is formed over the first reflector 110 and not over the second reflector 120.

According to a variant of this embodiment, the sacrificial layer 151 is etched before assembly of the upper reflector 110. Afterwards, the upper reflector 110 is affixed on the sacrificial layer 151, for example with a support substrate.

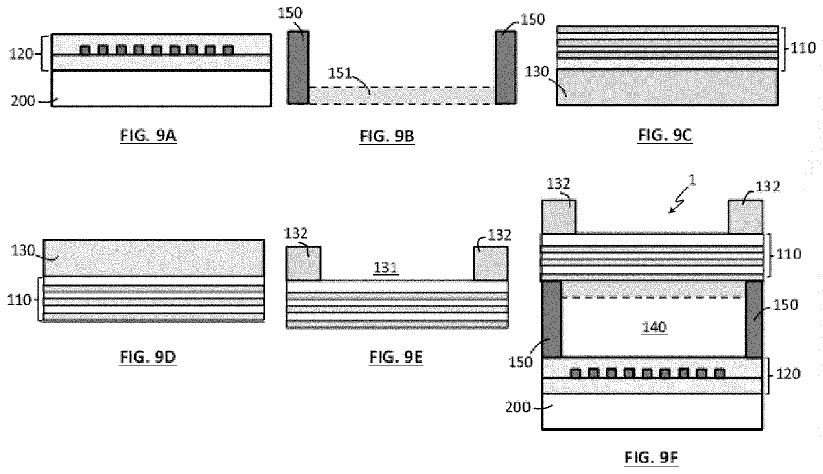

The embodiment described in FIGS. 8 to 8F has the advantage of being simple, easily reproducible and inexpensive. It is particularly well suited for detectors whose channel 140 has a relatively small thickness, the thickness being considered according to a direction perpendicular to the main plane in which the reflectors 110, 120 and the imager extend. FIGS. 9A to 9F illustrate the main steps of a second example of a method for making a detector according to the invention. This method is particularly well suited for making a detector whose channel 140 has a large thickness, for example from 50 μm to 1 mm. For example, a preferred application may concern low-consumption systems, which operate without a fluid pump and by natural convection.

The first steps may be similar to steps 7A and 7B of the previously-described method. Thus, a stack comprising a detection system 200 that consists of a PCM-based reflector 120 is provided.

As illustrated in FIG. 9B, a spacer forming at least one pillar 150, advantageously a network of pillars 150, is made beforehand, in parallel or subsequently. Preferably, the spacer is sized like a wafer. For example, this spacer forming the pillars 150 may be manufactured by three-dimensional (3D) printing or by moulding. Advantageously, the material used for the pillars 150 has a low coefficient of thermal expansion so as to have an optically stable cavity 100 in critical conditions, for example in the event of a fire. The height of the spacer forming the pillars 150 corresponds to the thickness of the channel 140. If the spacer has an element or a connecting portion 151 between the pillars 150, this connecting portion 151 preferably extends only over the periphery of the cavity to be formed. Thus, the connecting portion 151 provides for an opening at the center thereof for the passage of light and does not mask the reflectors. Preferably, the connecting portion 151 forms a frame for connecting the spacers 150. This frame corresponds to the periphery of the reflectors 110, 120. It will be polygonal if the reflectors 110, 120 are polygonal and will be circular if each of the reflectors 110, 120 forms a disk.

As illustrated in FIG. 9C, the first reflector 110 is made before, in parallel or subsequently to the steps illustrated in FIGS. 9A and 9B. In this example, the first reflector 110 is formed by another support substrate 130, for example made of silicon. The first reflector 110 may be a Bragg mirror or a PCM-based reflector.

FIG. 9D illustrates the stack integrating the first reflector 110 when turned around.

As illustrated in FIG. 9E, a deep etching of the substrate 130 is carried out afterwards until reaching the first reflector 110, that is to say the stack of layers of the Bragg mirror in this example. This opening of the substrate 130 allows illuminating the cavity 100 through the first reflector 110. Preferably, a closed periphery or pads 132 over the periphery of the substrate 130 are kept. According to an alternative embodiment, if the substrate 130 is transparent in the useful wavelength range, for example if the substrate is made of glass, then this deep etching step illustrated in FIG. 9E is not necessary.

As illustrated in FIG. 9F, the stacks made separately are assembled together. For example, these assemblies are done with optical glue. Thus, the stack comprising the first reflector 110 and the stack comprising the second reflector 120 are disposed on either side of the spacer forming the pillars 150.

A variant of this method consists in replacing the spacer forming the pillars 150 by structuring the substrate 130. In this case, a thick substrate 132, whose thickness corresponds to the desired height of the pillars 150 and of the channel 140, is typically provided. The spacer forming the pillars 150 and the first reflector 110 then belong to the same part and are turned around in order to be assembled with the stack comprising the PCM-based reflector 120.

In this variant, the thickness of the air area is limited by the thickness of the substrate 130, whose thickness is for example 725 μm.

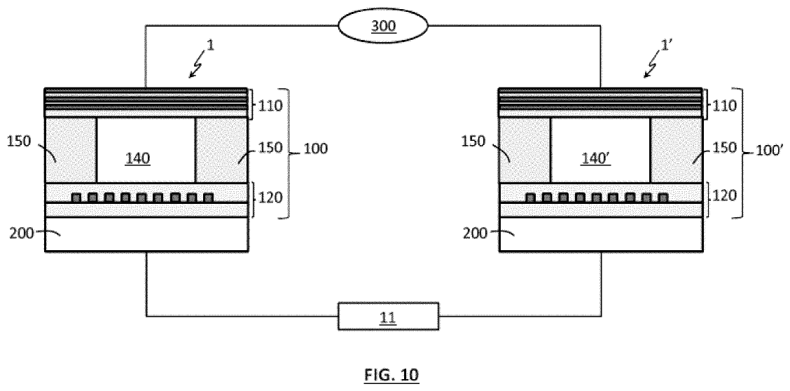

According to an embodiment illustrated in FIG. 10, a system comprising two resonant cavities 100, 100′ is provided. One of the two cavities 100, 100′ is open so that a fluid penetrates into the channel 140 to bring in possible particles. The other cavity 100′ is tight and devoid of particles. Thus, it constitutes a reference cavity. Thus, the space 140′ of the cavity 100′ is entirely delimited by the first 110 and second 120 reflectors and by a continuous wall forming a closed contour to define a closed space.

The use of a reference cavity 100′ with the detection cavity 100 within the same system allows improving even further the sensitivity of the detection. Indeed, the reference cavity 100′ allows identifying and therefore getting rid of a set of parameters that are not due to the particles but which are due to the other elements of the system, such as the signature of the imager or of a parasitic lighting due to the source 300. According to one embodiment, each cavity 100, 100′ is associated to an illumination system 310 which preferably shares the same source 300, a first reflector 110, a PCM-based reflector 120 and a detection system 200. Thus, this system comprises two detectors 1, 1′ in accordance with the descriptions hereinabove, with the difference that one of the two detectors 1, 1′ has a cavity 100′ isolated from the particles in order to form a reference cavity. It is possible to provide for the detection systems 200 of each of these detectors being coupled. Afterwards, the signals originating from these two detectors are analysed by a processing unit 11 of the system.

A detector having a tight reference cavity may be made in various ways. It may be made by means of the method illustrated in FIG. 9A to 9F. If the method illustrated in FIGS. 8A to 8F is used, the sacrificial layer 151 should be etched before assembly of the first 110 and second 120 reflectors. For this purpose, one of the two reflectors 110, 120 may be affixed on the already etched channel, this reflector then being carried by a support substrate.

In light of the previous description, it clearly comes out that the invention provides an effective solution to improve the sensitivity and the accuracy of the detector in particular to detect particles with very small dimensions, typically particles whose size is smaller than 500 nm and possibly smaller than 250 nm.

The invention is not limited to the described embodiments but encompasses any embodiment falling within the scope of claim 1.

In particular, it is possible to provide for interposing an optical system such as a lens between the PCM-based reflector 120 and the detection system 200, typically an array of photodetectors, so as to capture the image of the cavity mode 10 in the reciprocal space of the PCM-based reflector 120. This solution allows refining even further the analysis of the disturber present in the cavity 100.

1. A particle detector comprising:
at least one resonant cavity at least partially formed by a first reflector, a second reflector disposed at a distance from the first reflector and a channel located between the first and second reflectors, the channel being configured to receive at least one fluid comprising particles and to receive at least one light radiation; and
at least one detection system comprising at least one photodetector,
wherein the particle detector is configured so that a portion of the light radiation present in the channel escapes from the cavity throughout the second reflector and reaches the detection system, thereby enabling the at least one photodetector to detect leakages of the cavity,
and wherein the second reflector is a photonic crystal membranes PCM based reflector.

2. The detector according to claim 1, wherein the first reflector and the second reflector are disposed facing one another, extend in two parallel planes and are configured so as to form a resonant optical cavity having a cavity mode perpendicular to planes in which the first reflector and the second reflector primarily extend.

3. The detector according to claim 1, wherein the detection system includes a network of photodetectors arranged in a form of an array of photodetectors.

4. The detector according to claim 1, wherein the first reflector comprises or is composed by at least one Bragg mirror.

5. The detector according to claim 1, wherein the first reflector is a photonic crystal membranes PCM based reflector.

6. The detector according to claim 1, wherein the PCM-based second reflector has patterns made of a dielectric material and disposed periodically, at least one of features of the second reflector amongst a size of the patterns, a shape of the patterns, a period of the patterns, a thickness of the patterns and a refractive index of the second reflector being selected so that a maximum reflectivity of the second reflector corresponds to a wavelength belonging to the visible spectrum or near-infrared range.

7. The detector according to claim 1, wherein the PCM-based second reflector comprises patterns made of a dielectric material and at least one encapsulation layer covering the patterns and having a planar face, the at least one encapsulation layer being made of a dielectric material.

8. The detector according to claim 1, comprising at least one illumination system configured so as to convey the at least one light radiation into the cavity.

9. The detector according to claim 8, wherein the illumination system is configured so as to convey the at least one light radiation into the channel throughout the first reflector.

10. The detector according to claim 8, wherein the second reflector has an inner face facing the channel and an outer face opposite to the inner face, and wherein the illumination system comprises an injection waveguide configured so as to convey the at least one light radiation onto said outer face so as to excite the second reflector by evanescent-wave coupling.

11. The detector according to claim 8, wherein the first reflector is PCM based and has an inner face facing the channel and an outer face opposite to the inner face, and wherein the illumination system comprises an injection waveguide configured so as to convey the at least one light radiation onto said outer face so as to excite the first reflector by evanescent-wave coupling.

12. The detector according to claim 8, wherein the PCM-based second reflector has a flank, and wherein the illumination system comprises an injection waveguide configured so as to guide the at least one light radiation up to the flank of the PCM-based second reflector.

13. The detector according to claim 8, wherein the first reflector is PCM based and has a flank, and wherein the illumination system comprises an injection waveguide configured so as to guide the at least one light radiation up to the flank of the PCM-based first reflector.

14. The detector according to claim 8, comprising a light source optically coupled with the illumination system, the light source being a laser of a light-emitting diode LED.

15. The detector according to claim 2, comprising an optical device disposed between the second reflector the detection system, the optical device being configured so that an image of the cavity mode is located in a reciprocal space of the second reflector.

16. A detection system comprising a first detector according to claim 1 and a second detector, the second detector having a reference cavity configured to prevent particles from penetrating into the reference cavity, the system being further configured so as to couple data supplied by the detection system of the first detector with data supplied by a detection system of the second detector.

17. A system comprising at least one detector according to claim 1 wherein the system is selected amongst:
a fire alarm system,
a fire detection system,
a system for analysing a quality of a fluid,
a pollution alarm system,
an explosive powder detection system, and
a microbiological species detection system.

18. A method for manufacturing a particle detector according to claim 1, the method comprising:
providing at least one stack comprising the first reflector,
providing at least one stack comprising the second reflector, the second reflector being PCM based,
making pillars, and
assembling the first reflector and the second reflector so that the first reflector and the second reflector are located on either side of the pillars to form between the pillars a channel for passage of the at least one fluid.

19. The method according to claim 18, comprising:
prior to assembling the first reflector and the second reflector, providing a sacrificial layer over one amongst the first reflector and the second reflector,
prior to or after assembling the first reflector and the second reflector, removing a portion of the sacrificial layer while keeping another portion of the sacrificial layer so as to form the pillars and the channel.

20. The method according to claim 18, comprising:
making a spacer comprising said pillars,
wherein assembling the first reflector and the second reflector comprises positioning the spacer between the first reflector and the second reflector.
